(19) United States
(12) Patent Application Publication
(10) Pub. No.: US 2023/0332713 A1
(43) Pub. Date: Oct. 19, 2023

(54) PUSH-PULL VALVE ELEMENT

(71) Applicant: XINGXING ZHAO, YUHUAN (CN)

(72) Inventor: XINGXING ZHAO, YUHUAN (CN)

(21) Appl. No.: 17/659,476

(22) Filed: Apr. 15, 2022

(51) Int. Cl. F16K 31/524; F16K 11/00

(52) U.S. Cl. CPC F16K 31/52483; F16K 19/006

(57) ABSTRACT

The present invention relates to the field of sanitary ware technologies, and discloses a push-pull valve element, including a housing, a base connected to the housing, a fixed porcelain piece, a movable porcelain piece and a switching assembly. A cavity and a mounting hole are set on the housing. A water inlet runner I, a water inlet runner II and a water outlet runner are set on the base. A switching slot is formed in one side of the movable porcelain piece. The switching assembly is set in the mounting hole and is connected to the movable porcelain piece. The switching assembly may control the movable porcelain piece to move, so as to control a communication area among the water inlet runner I, the water inlet runner II and the switching slot. Therefore, the push-pull valve element is more practical in use.

### TECHNICAL FIELD

The invention relates to the technical field of sanitary ware technologies, and in particular, to a push-pull valve element.

### BACKGROUND ART

During push and pull, a push-pull faucet generally features a horizontal push-pull mode and a vertical push-pull mode. In a case of meeting a function of providing cold water and hot water, the push-pull faucet further meets a push-pull function. As a result, compared with a pure cold-hot-water faucet, the push-pull faucet featuring a valve element structure is complex, and needs to mutually adapt to a faucet.

The applicant learns that a push-pull valve element in the prior art is not directly in butt joint to a water outlet of a faucet, but is featured in connecting the water outlet of the faucet to a valve element via a push-pull hose. A water inlet and a water outlet on the push-pull valve element are perpendicular to ground, and therefore, a flange cover further needs to be additionally set on the valve element so as to enable the valve element to be in butt joint to tubes in different directions through the flange cover. The push-pull valve element features a complex structure, and is likely to have part losing or damage during mounting and dismounting for maintenance as there are many movable parts. Consequently, there is a water leakage risk between the valve element and the flange cover, and therefore, the push-pull valve element is not practical in use.

### TECHNICAL SOLUTION OF THE INVENTION

To overcome the shortcomings in the prior art, the present invention aims to provide a push-pull valve element. The push-pull valve element features the advantage of being practical in use.

The technical objective of the present invention is implemented through the following technical solution: a push-pull valve element includes a housing, a base, a fixed porcelain piece, a movable porcelain piece and a switching assembly. A cavity and a mounting hole in communication with the cavity are set on the housing. The base is connected to the housing. A water inlet runner I, a water inlet runner II and a water outlet runner are set on the base; the fixed porcelain piece is peripherally limited in the cavity; the water inlet runner I, the water inlet runner II and one end, close to the fixed porcelain piece, of the water outlet runner penetrate through the fixed porcelain piece; the water inlet runner I, the water inlet runner II and the other end of the water outlet runner are perpendicular to a central axis of the housing; the movable porcelain piece is movably set in the cavity and clings to the fixed porcelain piece; a switching slot is formed in one side, close to the fixed porcelain piece, of the movable porcelain piece. The water outlet runner is in communication with the water inlet runner I and/or the water inlet runner II through the switching slot. The switching assembly is set in the mounting hole and is connected to the movable porcelain piece. The switching assembly may control the movable porcelain piece to move, so as to control a communication area among the water inlet runner I, the water inlet runner II and the switching slot.

According to the technical solution, a cold water supply tube is connected to the water inlet runner I. A hot water supply tube is connected to the water inlet runner II. Cold water enters the water inlet runner I, and hot water enters the water inlet runner II. The switching assembly controls the movable porcelain piece to rotate or slide in the cavity, so that the water inlet runner I and/or the water inlet runner II is in communication with the switching slot. After the switching slot is in communication with the water outlet runner, the valve element is opened. When the water inlet runner I is in communication with the water outlet runner through the switching slot, cold water is discharged through the water inlet runner I, the switching slot and the water outlet runner. When the water inlet runner II is in communication with the water outlet runner through the switching slot, hot water is discharged through the water inlet runner II, the switching slot and the water outlet runner. When both the water inlet runner I and the water inlet runner II are in communication with the water outlet runner, cold water and hot water are mixed in the switching slot, and are discharged through the water outlet runner. The water inlet runner I, the water inlet runner II and one end, away from the fixed porcelain piece, of the water outlet runner are perpendicular to the central axis of the housing, so that the valve element is connected to a push-pull faucet conveniently, and is more practical in use.

Preferably, the switching assembly includes a valve stem, a connector and a driving lever. The valve stem is rotatably set in the mounting hole. The connector is set between the movable porcelain piece and the valve stem. The valve stem can control the connector and the fixed porcelain piece to rotate. A through hole is formed in the valve stem. The driving lever is hinged in the through hole. The driving lever can control the connector and the movable porcelain piece to slip.

According to the technical solution, the valve stem is connected to the driving lever. When the valve stem controls the connector and the movable porcelain piece to rotate, the valve stem, the driving lever and the movable porcelain piece integrally rotate, so as to control a communication area between the switching slot and the water inlet runner I and/or the water inlet runner II. When the driving lever drives the connector, the connector and the movable porcelain piece can integrally slip, so as to control connection and disconnection between the switching slot, and the water inlet runner I and the water inlet runner II.

Preferably, a slide block is set on the connector. A slide slot adaptive to the slide block is formed in the inner end of the valve stem. The slide block is connected in the slide slot in a slip manner. The slide slot peripherally limits the slide block. An assembly hole for allowing the inner end of the driving lever to extend into is formed in the connector. The driving lever can drive the connector and the movable porcelain piece to slip.

According to the technical solution, the slide block is connected to the slide slot in a slip manner. When the driving lever drives the connector, the slide block on the connector slips in a length direction of the slide slot, so as to realize control on slip of the movable porcelain piece. The slide slot limits the slide block. When the valve stem rotates, the connector and the movable porcelain piece may be controlled to rotate synchronously to implement control on rotation of the movable porcelain piece.

Preferably, a reinforcing block I and a reinforcing block II are symmetrically set at one side, close to the valve stem, of the assembly hole. The inner end of the driving lever can abut against the reinforcing block I and the reinforcing block II. An avoiding groove for allowing the reinforcing block I and the reinforcing block II to slip is formed in the inner end of the valve stem.

According to the technical solution, structural strength of the assembly hole is improved through the reinforcing block I and the reinforcing block II, so that the service life of the connector is prolonged. The reinforcing block I and the reinforcing block II slip or rotate in the cavity, and the avoiding groove can avoid movement of the reinforcing block I and the reinforcing block II.

Preferably, a travel groove is formed in the cavity. A positioning block is set at the inner end of the valve stem. The valve stem can drive the positioning block to rotate in the travel groove.

According to the technical solution, the positioning block rotates along with the valve stem, the travel groove limits a rotation travel of the positioning block, so as to ensure that the rotation travel of the valve stem and the movable porcelain piece is within a predetermined range.

Preferably, an adjusting ring is set at the outer end of the valve stem in a slip manner. A connecting part is set on the adjusting ring. The connecting part is adaptive to the outer end of the valve stem. The connecting part can be connected to or disconnected from the outer end of the valve stem. A locking block I is set on the adjusting ring. A locking block II is set on the housing. The locking block II can peripherally limit the locking block I.

According to the technical solution, after the adjusting ring is connected to the outer end of the valve stem, the adjusting ring rotates along with the valve stem, and the locking block I is limited by the locking block II while rotating along with the adjusting ring, so as to limit a rotation angle of the valve stem. A rotation travel of the valve stem may be shortened to reduce a rotatable angle of the movable porcelain piece, so that the water inlet runner II is prevented from being in communication with the entire switching slot, to control a maximum water outlet temperature. In a using process, children are prevented from being burnt due to a too high water outlet temperature. After the adjusting ring is pulled out, limit on the rotation angle of the valve stem by the adjusting ring can be relieved.

Preferably, the connecting part includes inner gears set in the adjusting ring. Gear slots engaged with the inner gears are set at the outer end of the valve stem. The inner gears can slip in a length direction of the gear slots.

According to the technical solution, the adjusting ring is connected to the outer end of the valve stem through the gear slots and the inner gears. The adjusting ring is reconnected to the outer end of the valve stem after being pulled out and rotated for a specific angle, so that the adjusting ring can adjust a rotatable angle of the valve stem. To be specific, a maximum water outlet temperature of the valve element is adjustable.

Preferably, a recessing groove is formed in the slide block. A mounting slot I is formed in the recessing groove. A round rod I is set in the mounting slot I in a rolling manner. A mounting slot II is formed in one side, close to the recessing groove, of the valve stem. A round rod II is set in the mounting slot II in the rolling manner. The round rod II may slip in the recessing groove. The round rod I may be close to or away from the round rod II. A position on which the round rod I is in contact with the round rod II corresponds to a start state of the valve element. The round rod I may emit a prompt tone after getting across the round rod II.

According to the technical solution, when the driving lever drives the connector to slip, the connector integrally moves together with the round rod I. The round rod I gets close to or away from the round rod II along with slip of the connector. After the round rod I is in contact with the round rod II, the water inlet runner I and/or the water inlet runner II is in communication with the entire switching slot, to be specific, the valve element is opened. After the round rod I abuts against the round rod II, opening resistance of the driving lever is increased, so that a user is reminded that the valve element is in a completely open state from a hand touch of the user. After the round rod I gets across the round rod II, the emitted prompt tone can remind the user that the valve element is in the completely open state. In this way, the push-pull valve element improves use experience of the user, and is more convenient for use by the user.

Preferably, the round rod I is protruded out of a slot opening of the mounting slot I. The round rod II is protruded out of a slot opening of the mounting slot II. The round rod II can roll between the recessing groove and the mounting slot II.

According to the technical solution, the round rod I protruded out of the mounting slot I, and the round rod II protruded out of the mounting slot II can be in contact with each other to increase slip resistance of the connector. When the round rod I abuts against the round rod II, the valve stem is slightly deformed. After the round rod I gets across the round rod II, the round rod I hits against the recessing groove under return effect of the valve stem to emit a prompt tone.

Preferably, blocking pins and blocking hooks are set on the base. Blocking slots adaptive to the blocking pins are formed in the fixed porcelain piece. The blocking pins peripherally limit the fixed porcelain piece after being inserted into the blocking slots. Connecting holes adaptive to the blocking hooks are formed in the housing. The blocking hooks are connected to the connecting holes.

According to the technical solution, after the blocking bins are connected to the blocking slots, the fixed porcelain piece is peripherally limited in the cavity through the base, to ensure stability of relative positions among the water inlet runner I, the water inlet runner II and the water outlet runner. After the blocking hooks on the base are connected to the blocking holes, the base may be connected to the housing, so that the base and the housing are convenient to mount and dismount.

In summary, compared with the prior art, the present invention features the beneficial effects:
1. The water inlet runner I, the water inlet runner II and one end, away from the fixed porcelain piece, of the water outlet runner are perpendicular to the central axis of the housing, so that the valve element is connected to a push-pull faucet conveniently, and is more practical in use.
2. The rotatable angle of the valve stem may be adjusted to control the maximum water outlet temperature and prevent the children from being burnt.
3. The valve element may emit a prompt tone when in a completely open state, and increases opening resistance of the driving lever to remind the user of the opening state of the valve element through hand touch or sound of the user. In this way, the push-pull valve element improves use experience of the user and is more convenient for use by the user.

### BRIEF DESCRIPTION OF DRAWINGS

FIG. 1 is a schematic diagram showing an external structure of an embodiment.

FIG. 2 is a schematic diagram showing a complete section structure of FIG. 1.

FIG. 3 is a schematic diagram showing an explosion structure of FIG. 1.

FIG. 4 is a structural diagram showing a partial explosion structure of FIG. 1.

FIG. 5 is a structural diagram showing an explosion structure of a valve stem and a connector.

FIG. 6 is a schematic diagram showing a complete section structure of a valve stem and a connector.

FIG. 7 is a structural diagram showing a partial explosion structure of FIG. 1.

FIG. 8 is a schematic diagram showing another side structure of FIG. 7.

### REFERENCE NUMERALS

100, housing; 110, cavity; 111, travel slot; 120, mounting hole; 130, locking block II; 140, connecting hole; 200, base; 210, water inlet runner I; 220, water inlet runner II; 230, water outlet runner; 240, blocking pin; 250, blocking hook; 260, connecting thread; 300, fixed porcelain piece; 310, blocking slot; 400, movable porcelain piece; 410, switching slot; 420, connecting slot; 500, switching assembly; 510, valve stem; 511, through hole; 512, slide slot; 5121, bump; 513, avoiding groove; 514, positioning block; 515, gear slot; 516, mounting slot II; 5161, round rod II; 520, connector; 521, slide block; 5211, recessing groove; 5212, mounting slot I; 5213, round rod I; 522, assembly hole; 5221, reinforcing block I; 5222, reinforcing block II; 523, connecting pin; 530, driving lever; 531, ball head; 600, adjusting ring; 610, connecting part; 611, inner gear; and 620, locking block I.

### DETAILED DESCRIPTION

In the description of the present invention, it is to be understood that orientation or position relationships indicated by terms “upper”, “lower”, “inner”, “outer” and the like are orientation or position relationships shown in the drawings, are adopted not to indicate or imply that indicated devices or components must be in specific orientations or structured and operated in specific orientations but only to conveniently describe the present invention and simplify the description and thus should not be understood as limits to the present invention.

The present invention will be described in detail in conjunction with the drawings.

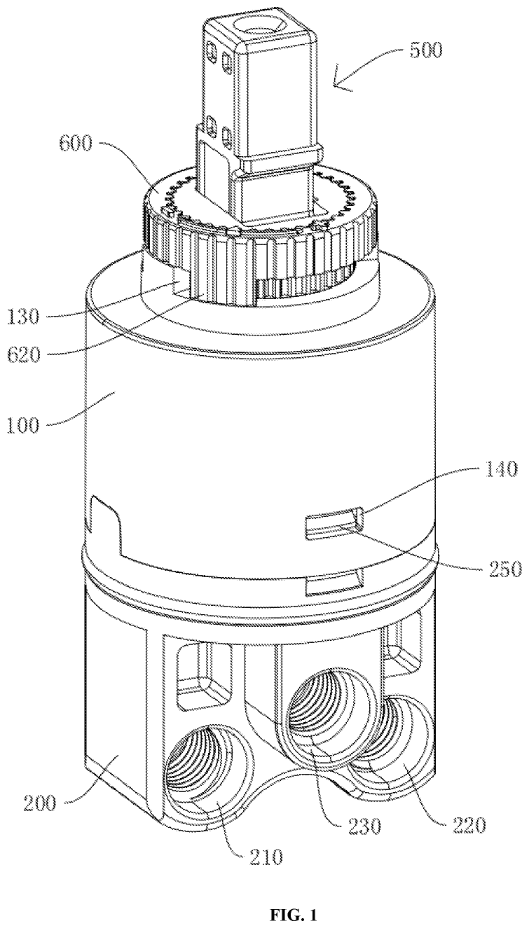

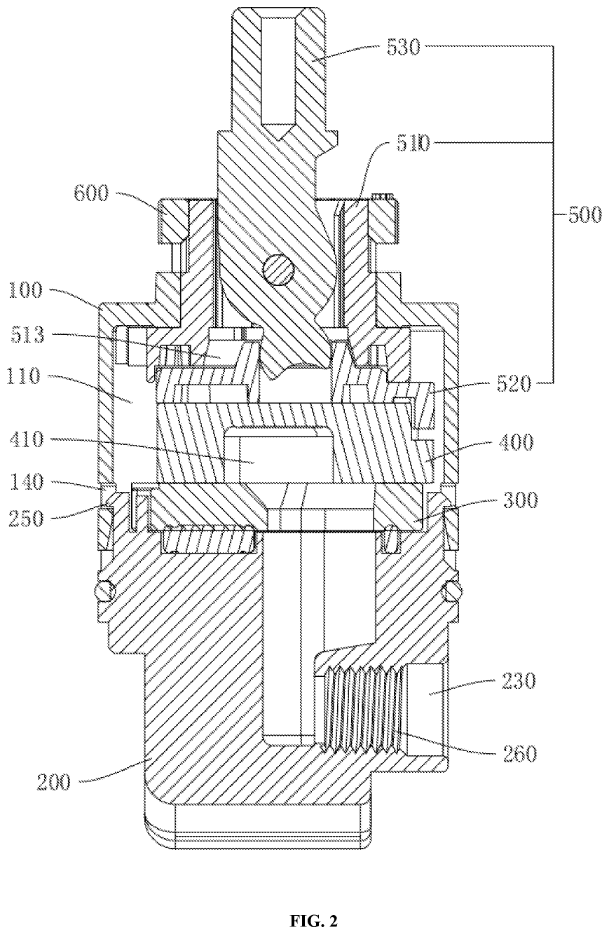

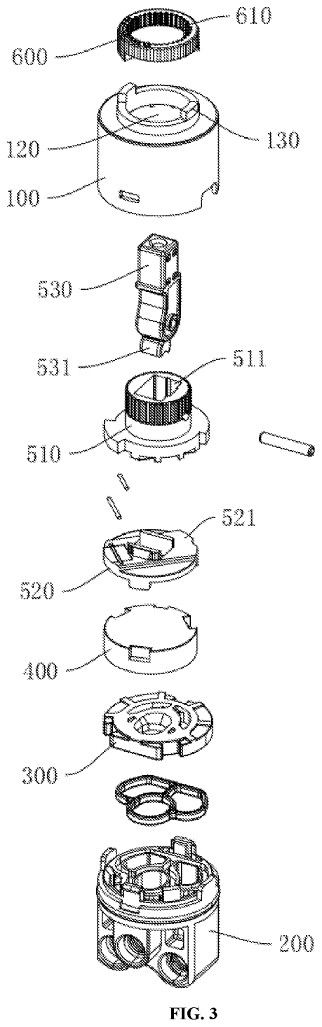

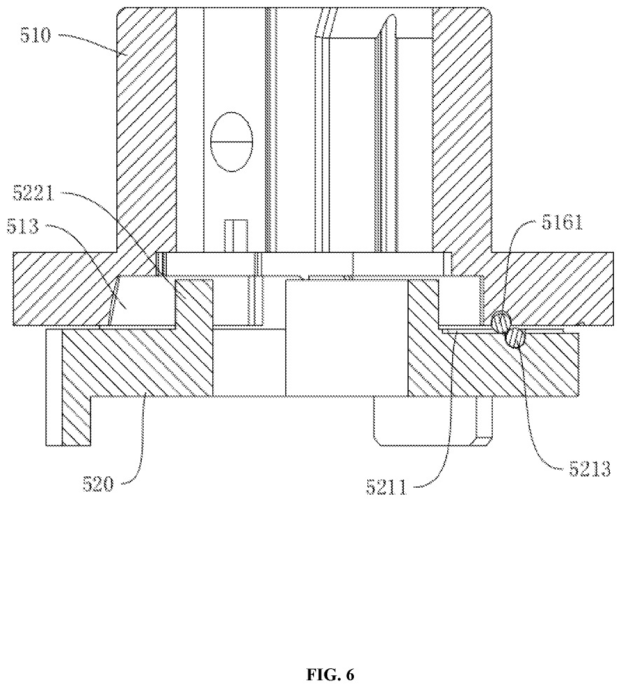

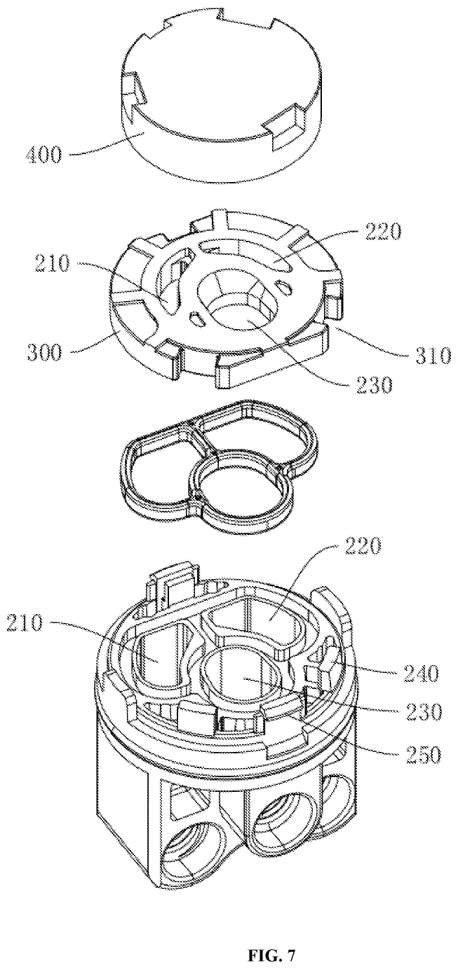

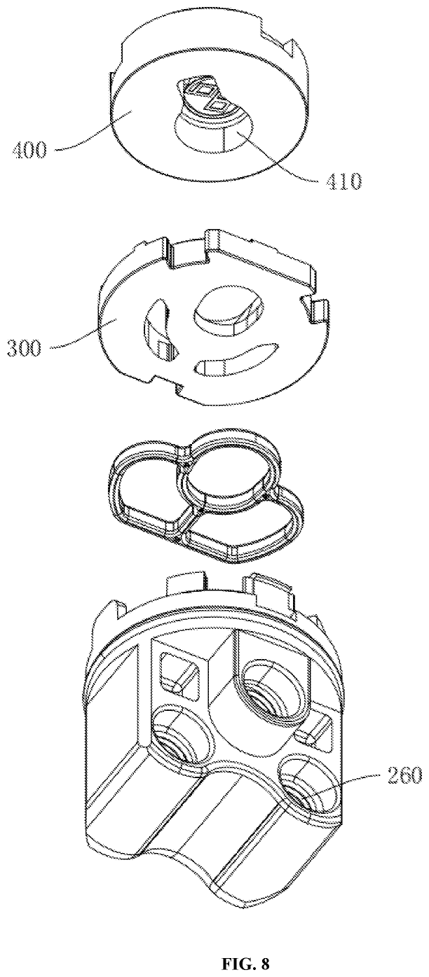

As shown in FIG. 1 to FIG. 8, a push-pull valve element includes a housing 100, a base 200, a fixed porcelain piece 300, a movable porcelain piece 400 and a switching assembly 500. A cavity 110 and a mounting hole 120 in communication with the cavity 110 are set on the housing 100. The base 200 is connected to the housing 100. A water inlet runner I 210, a water inlet runner II 220 and a water outlet runner 230 are set on the base 200. The water outlet runner 230 is located between the water inlet runner I 210 and the water inlet runner 220. A connecting thread 260 is set in each of the water inlet runner I 210, the water inlet runner II 220 and the water outlet runner 230. The fixed porcelain piece 300 is peripherally limited in the cavity 110. The water inlet runner I 210, the water inlet runner II 220 and one end, close to the fixed porcelain piece 300, of the water outlet runner 230 penetrate through the fixed porcelain piece 300. The water inlet runner I 210, the water inlet runner II 220 and the other end of the water outlet runner 230 are perpendicular to a central axis of the housing 100. To be specific, after the valve element is mounted, the water inlet runner I 210, the water inlet runner II 220 and the water outlet runner 230 face towards the ground. The movable porcelain piece 400 is movably set in the cavity 110 and clings to the fixed porcelain piece 300. A switching slot 410 is formed in one side, close to the fixed porcelain piece 300, of the movable porcelain piece 400. The switching slot 410 can change a communication area between the switching slot and the water inlet runner I 210 and/or the water inlet runner II 220. The switching assembly 500 is set in the mounting hole 120 and is connected to the movable porcelain piece 400. The switching assembly 500 may control the movable porcelain piece 400 to move, so as to control a communication area among the water inlet runner I 210, the water inlet runner II 220 and the switching slot 410.

The switching assembly 500 includes a valve stem 510, a connector 520 and a driving lever 530. The valve stem 510 is rotatably set in the mounting hole 120. The connector 520 is set between the movable porcelain piece 400 and the valve stem 510. The valve stem 510 can control the connector 520 and the fixed porcelain piece 400 to rotate. A through hole 511 is formed in the valve stem 510. The driving lever 530 is hinged in the through hole 511. The driving lever 530 can control the connector 520 and the movable porcelain piece 400 to slip.

Specially, a connecting pin 523 is set at the inner end of the connector 520. A connecting slot 420 for allowing the connecting pin 523 to insert is formed in the movable porcelain piece 400. After the connecting pin 523 is inserted into the connecting slot 420, the connector 520 limits the movable porcelain piece 400.

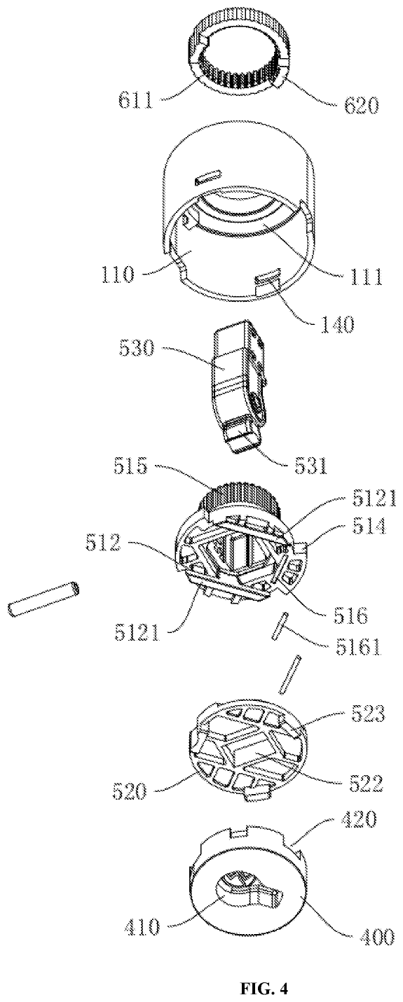

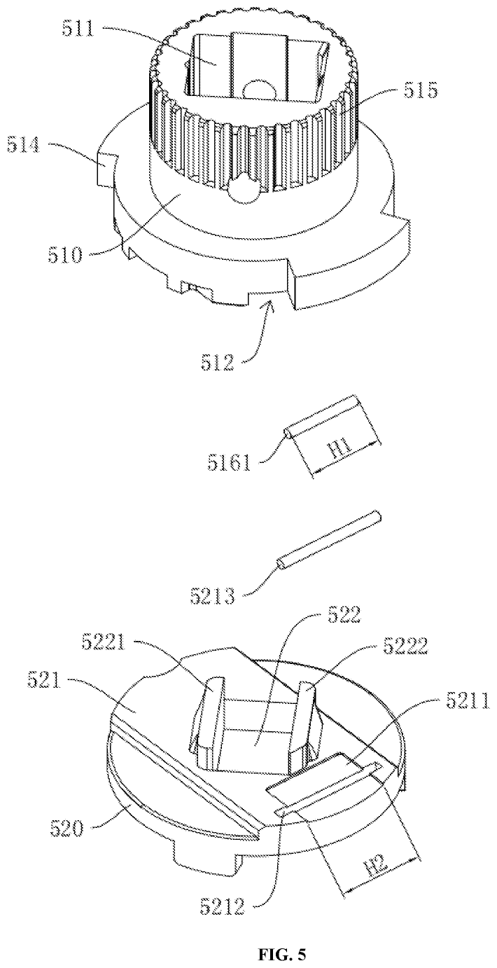

As shown in FIG. 4 and FIG. 5, a slide block 521 is set on the connector 520. A slide slot 512 adaptive to the slide block 521 is set at the inner end of the valve stem 510. The slide block 521 is connected in the slide slot 512 in a slip manner. The slide slot 512 peripherally limits the slide block 521. The slide slot 512 may be formed by two bumps 5121 that are parallel to each other, and an area between the two bumps 5121 is the slide slot 512. An assembly hole 522 for allowing the inner end of the driving lever 530 to extend into is formed in the connector 520. The driving lever 530 can drive the connector 520 and the movable porcelain piece 400 to slip. Further, the inner end, extending into the assembly hole 522, of the driving lever 530 is a ball head 531, and the outer side wall of the ball head 531 is in contact with the assembly hole 522.

A reinforcing block I 5221 and a reinforcing block II 5222 are symmetrically set at one side, close to the valve stem 510, of the assembly hole 522. The inner end of the driving lever 530 can abut against the reinforcing block I 5221 and the reinforcing block II 5222. An avoiding groove 513 for allowing the reinforcing block I 5221 and the reinforcing block II 5222 to slip is formed in the inner end of the valve stem 510.

A travel groove 111 is formed in the cavity 110. A positioning block 514 is set at the inner end of the valve stem 510. The valve stem 510 can drive the positioning block 514 to rotate in travel groove 111. There may be two travel slots 111 and two positioning blocks 514 correspondingly. Each positioning block 514 slips in one travel slot 111.

An adjusting ring 600 is set at the outer end of the valve stem 510 in a slip manner. A connecting part 610 is set on the adjusting ring 600. The connecting part 610 is adaptive to the outer end of the valve stem 510. The connecting part 610 can be connected to or disconnected from the outer end of the valve stem 510. A locking block I 620 is set at one side, close to the housing 100, of the adjusting ring 600. A locking block II 130 is set on the housing 100. The locking block II 130 can peripherally limit the locking block I 620.

Specifically, two locking blocks II 130 are symmetrically set, and two locking blocks I 620 are also symmetrically set, to ensure that each locking block I 620 is positioned between the two locking blocks II 130. The inner ends of the locking blocks I 620 can abut against the housing 100 to axially limit the adjusting ring 600. Or, the outer ends of the locking blocks II 130 can abut against the adjusting ring 600 to axially limit the adjusting ring 600, to ensure that the adjusting ring 600 is fixed in relative position on the valve stem 510.

The connecting part 610 includes inner gears 611 formed in adjusting ring 600. Gear slots 515 engaged with the inner gears 611 are set at the outer end of the valve stem 510. The inner gears 611 can slip in a length direction of the gear slots 515. According to other solutions, the connecting part 610 alternatively may include a plurality of vertical grooves that are peripherally distributed at intervals. When the connecting part 610 is connected to the outer end of the valve stem 510 in the slip manner, the outer end of the valve stem 510 can peripherally limit the adjusting ring 600.

Further, a recessing groove 5211 is formed in the slide block 521. Alternatively, the recessing groove 5211 may be set on other part of the connector 520. A mounting slot I 5212 is formed in the recessing groove 5211. A round rod I 5213 is set in the mounting slot I 5212 in a rolling manner. A mounting slot II 516 is formed in one side, close to the recessing groove 5211, of the valve stem 510. A round rod II 5161 is set in the mounting slot II 516 in the rolling manner. The round rod II 5161 has a length of H1 and the recessing groove 5211 has a width of H2, where H1 is smaller than H2. It is ensured that the round rod II 5161 may roll or slip in the avoiding groove 5211. The round rod I 5213 may be close to or away from the round rod II 5161. A position on which the round rod I 5213 is in contact with the round rod II 5161 corresponds to a completely open state of the valve element. The round rod 5213 may emit a prompt tone after getting across the round rod II 5161.

The round rod I 5213 and the round rod II 5161 are preferably made of a wear-resisting metal material. The round rod I 5213 is protruded out of a slot opening of the mounting slot I 5212. The round rod II 5161 is protruded out of a slot opening of the mounting slot II 516. The round rod 5161 can roll between the avoiding groove 5211 and the mounting slot II 516.

Blocking pins 240 and blocking hooks 250 are set on the base 200. Blocking slots 310 adaptive to the blocking pins 240 are formed in the fixed porcelain piece 300. The blocking pins 240 peripherally limit the fixed porcelain piece 300 after being inserted into the blocking slots 310. Connecting holes 140 adaptive to the blocking hooks 250 are formed in the housing 100. The blocking hooks 250 are connected to the connecting holes 140.

The working principle is as follows:

The cold water supply tube is connected to the water inlet runner I 210, the hot water supply tube is connected to the water inlet runner II 220, and the push-pull hose is connected to the water outlet runner 230, so that cold water enters the water inlet runner I 210 and hot water enters the water inlet runner II 220.

The driving lever 530 is driven to enable the connector 520 and the movable porcelain piece 400 to integrally slip in the length direction of the slide slot 512, and the switching slot 410 is close to the water inlet runner I 210 and the water inlet runner II 220. After the round rod I 5213 is in contact with the round rod II 5161, the water inlet runner I 210 and/or the water inlet runner II 220 and the switching slot 410 are completely in communication, to be specific, the valve element is in the completely open state. In addition, the opening resistance of the driving lever 530 is increased and transmitted to hands of the user, so that the valve stem 510 is slightly deformed. After the round rod I 5213 gets across the round rod II 5161, the round rod I 5213 hits against the avoiding groove 5211 under the return effect of the valve stem 510 to emit the prompt tone. In this way, use experience of the user is improved. The driving lever 530 is reversely driven to enable the connector 520 and the movable porcelain piece 400 to reversely slip. The round rod I 5213 returns and gets across the round rod II 5161 to emit the prompt tone. After the switching slot 410 is not in communication with the water inlet runner 210 and the water inlet runner 220, the valve element is in a closed state.

When the valve element is in the open state, the valve stem 510 is rotated to enable the adjusting ring 600, the driving lever 530, the connector 520 and the movable porcelain piece 400 to rotate along with the valve stem 510, so that the positioning block 514 slips in the travel groove 111 along with rotation of the valve stem 510.

When the movable porcelain piece 400 rotates to the switching slot 410 for enabling the water inlet runner I 210 to be in communication with the water outlet runner 230, cold water in the water inlet runner I 210 enters the water outlet runner 230 through the switching slot 410 and is discharged through the push-pull hose, and hot water is blocked in the water inlet runner II 220 by the movable porcelain piece 400. When the movable porcelain piece 400 rotates to the switching slot 410 for enabling the water inlet runner II 220 to be in communication with the water outlet runner 230, hot water in the water inlet runner II 220 enters the water outlet runner 230 through the switching slot 410 and is discharged through the push-pull hose, and cold water is blocked in the water inlet runner I 210 through the movable porcelain piece 400. When the movable porcelain piece 400 rotates to the switching slot 410 for enabling the water inlet runner I 210 to be in communication with the water inlet runner II 220, cold water in the water inlet runner I 210 and hot water in the water inlet runner II 220 pass through the switching slot 410 and enter the water outlet runner 230 to form warm water. Then, the warm water is discharged through the push-pull hose. The valve stem 510 is rotated leftwards or rightwards to change the communication area among the water inlet runner I 210, the water inlet runner II 220 and the switching slot 410. In this way, a proportion of cold water entering the switching slot 410 to hot water entering the switching slot 410 may be changed to control a water outlet temperature.

The adjusting ring 600 is reinserted into the outer end of the valve stem 510 after being pulled out and rotated for a specific angle, so that a spacing between the locking block I 620 and the locking block II 130 may be changed. In addition, the positioning block 514 is limited by the travel groove 111, and the rotatable angle of the valve stem 510 is reduced, so that the rotatable angle of the movable porcelain piece 400 is reduced and the water inlet runner II 220 is prevented from being completely in communication with the switching slot 410. Consequently, the maximum water outlet temperature is controlled and the children are prevented from being burnt due to a too high water outlet temperature in a water consumption process. The adjusting ring 600 is reinserted into the outer end of the valve stem 510 after being pulled out and reversely rotated by a specific angle, to normally use the valve element again.

The above are exemplary embodiments of the present invention, which are not intended to limit the protection range of the present invention. Therefore, the protection scope of the present invention is subject to claims appended.

What is claimed is:

1. A push-pull valve element, comprising a housing (100), a base (200), a fixed porcelain piece (300), a movable porcelain piece (400) and a switching assembly (500), wherein a cavity (110) and a mounting hole (120) in communication with the cavity (110) are set on the housing (100); the base (200)is connected to the housing (100); a water inlet runner I (210), a water inlet runner II (220) and a water outlet runner (230) are set on the base (200); the fixed porcelain piece (300) is peripherally limited in the cavity (110); the water inlet runner I (210), the water inlet runner II (220) and one end, close to the fixed porcelain piece (300), of the water outlet runner (230) penetrate through the fixed porcelain piece (300); the water inlet runner I (210), the water inlet runner II (220) and the other end of the water outlet runner (230) are perpendicular to a central axis of the housing (100); the movable porcelain piece (400) is movably set in the cavity (110) and clings to the fixed porcelain piece (300); a switching slot (410) is formed in one side, close to the fixed porcelain piece (300), of the movable porcelain piece (400); the water outlet runner (230) is in communication with the water inlet runner I (210) and/or the water inlet runner II (220) through the switching slot (410); the switching assembly (500) is set in the mounting hole (120) and is connected to the movable porcelain piece (400); and the switching assembly (500) may control the movable porcelain piece (400) to move, so as to control a communication area among the water inlet runner I (210), the water inlet runner II (220) and the switching slot (410).

2. The valve element according to claim 1, wherein the switching assembly (500) comprises a valve stem (510), a connector (520) and a driving lever (530); the valve stem (510) is rotatably set in the mounting hole (120); the connector (520) is set between the movable porcelain piece (400) and the valve stem (510); the valve stem (510) can control the connector (520) and the fixed porcelain piece (400) to rotate; a through hole (511) is formed in the valve stem (510); the driving lever (530) is hinged in the through hole (511); and the driving lever (530) can control the connector (520) and the movable porcelain piece (400) to slip.

3. The valve element according to claim 2, wherein a slide block (521) is set on the connector (520); a slide slot (512) adaptive to the slide block (521) is formed in the inner end of the valve stem (510); the slide block (521) is connected in the slide slot (512) in a slip manner; the slide slot (512) peripherally limits the slide block (521); an assembly hole (522) for allowing the inner end of the driving lever (530) to extend into is formed in the connector (520); and the driving lever (530) can drive the connector (520) and the movable porcelain piece (400) to slip.

4. The valve element according to claim 3, wherein a reinforcing block I (5221) and a reinforcing block II (5222) are symmetrically set at one side, close to the valve stem (510), of the assembly hole (522); the inner end of the driving lever (530) can abut against the reinforcing block I (5221) and the reinforcing block II (5222); and an avoiding groove (513) for allowing the reinforcing block I (5221) and the reinforcing block II (5222) to slip is formed in the inner end of the valve stem (510).

5. The valve element according to claim 3, wherein a travel groove (111) is formed in the cavity (110); a positioning block (514) is set at the inner end of the valve stem (510); and the valve stem (510) can drive the positioning block (514) to rotate in the travel groove (111).

6. The valve element according to claim 3, wherein an adjusting ring (600) is set at the outer end of the valve stem (510) in a slip manner; a connecting part (610) is set on the adjusting ring (600); the connecting part (610) is adaptive to the outer end of the valve stem (510); the connecting part (610) can be connected with or disconnected from the outer end of the valve stem (510); a locking block I (620) is set on the adjusting ring (600); a locking block II (130) is set on the housing (100); and the locking block II (130) can peripherally limit the locking block I (620).

7. The valve element according to claim 6, wherein the connecting part (610) comprises inner gears (611) formed in the adjusting ring (600); gear slots (515) engaged with the inner gears (611) are set at the outer end of the valve stem (510); and the inner gears (611) can slip in a length direction of the gear slots (515).

8. The valve element according to claim 5, wherein a recessing groove (5211) is formed in the slide block (521); a mounting slot I (5212) is formed in the recessing groove (5211); a round rod I (5213) is set in the mounting slot I (5212) in a rolling manner; a mounting slot II (516) is formed in one side, close to the recessing groove (5211), of the valve stem (510); a round rod II (5161) is set in the mounting slot (516) in the rolling manner; the round rod II (5161) may slip in the recessing groove (5211); the round rod I (5213) may be close to or away from the round rod II (5161); a position on which the round rod I (5213) is in contact with the round rod II (5161) corresponds to a start state of the valve element; and the round rod I (5213) may emit a prompt tone after getting across the round rod II (5161).

9. The valve element according to claim 8, wherein the round rod I (5213) is protruded out of a slot opening of the mounting slot I (5212); the round rod II (5161) is protruded out of a slot opening of the mounting slot II (516); and the round rod II (5161) can roll between the recessing groove (5211) and the mounting slot II (516).

10. The valve element according to claim 1, wherein blocking pins (240) and blocking hooks (250) are set on the base (200); blocking slots (310) adaptive to the blocking pins (240) are formed in the fixed porcelain piece (300); the blocking pins (240) peripherally limit the fixed porcelain piece (300) after being inserted into the blocking slots (310); connecting holes (140) adaptive to the blocking hooks (250) are formed in the housing (100); and the blocking hooks (250) are connected to the connecting holes (140).
